(19) United States
(12) Patent Application Publication
(10) Pub. No.: US 2014/0116937 A1
(43) Pub. Date: May 1, 2014

(54) APPARATUS AND METHOD FOR SEWAGE SLUDGE TREATMENT AND ADVANCED SEWAGE TREATMENT

(71) Applicant: KOREA INSTITUTE OF SCIENCE AND TECHNOLOGY, Seoul (KR)

(72) Inventors: Yong Su Choi, Seoul (KR); Kyo Bum Kim, Seoul (KR); Jae Shik Chung, Seoul (KR); Yong Bae Park, Seoul (KR); Kyu Won Seo, Seoul (KR)

(73) Assignee: KOREA INSTITUTE OF SCIENCE AND TECHNOLOGY, Seoul (KR)

(21) Appl. No.: 13/956,763

(22) Filed: Aug. 1, 2013

(30) Foreign Application Priority Data
Oct. 29, 2012 (KR) 10-2012-0120145

(51) Int. Cl. C02F 11/04

(52) U.S. Cl. CPC C02F 11/04
USPC 210/605; 210/151; 210/630

(57) ABSTRACT

A sludge treatment apparatus includes an aeration tank serving to degrade microorganisms other than Bacillus sp. in sludge to produce organic matter to thereby activate Bacillus sp.; a poor aeration tank serving to reduce the activity of microorganisms in the sludge; a spore-forming tank operated under oxygen-free conditions and serving to induce the degradation and death of microorganisms remaining in the sludge while inducing the formation of spores of Bacillus sp.; a Bacillus sp.-activating reactor provided in an internal return line extending from the spore-forming tank to the aeration tank and serving to supply minerals to the sludge returned from the spore-forming tank to activate spore-type Bacillus sp.; and a sedimentation tank serving to induce the gravity sedimentation of the sludge discharged from the spore-forming tank to separate the discharged sludge into a supernatant and a concentrated sludge.

### CROSS-REFERENCE TO RELATED APPLICATION

This application claims priority to Korean Patent Application No. 10-2012-120145, filed on Oct. 29, 2012, and all the benefits accruing therefrom under 35 U.S.C. §119, the contents of which in its entirety are herein incorporated by reference.

### BACKGROUND

1. Field

The present disclosure relates to an apparatus and method for sewage sludge treatment and advanced sewage treatment, and more particularly to an apparatus and method for sewage sludge treatment and advanced sewage treatment, which can treat nutrients such as nitrogen and phosphorus while fundamentally eliminating or minimizing the discharge of excess sludge by using a combination of an advanced sewage treatment process and a sludge treatment process and applying Bacillus sp. in the sludge treatment process.

2. Description of the Related Art

Sludge treatment technologies can be largely divided into aerobic digestion and anaerobic digestion. The aerobic digestion is a process in which microorganisms consume their own protoplasm to obtain energy for cell maintenance, as available substrate is depleted. It is also referred to as endogenous respiration. Typical aerobic digestion processes include conventional aerobic digestion, high-purity oxygen aerobic digestion and autothermal thermophilic digestion processes. Meanwhile, the anaerobic digestion is an important process for sludge stabilization, which generates methane gas in an amount enough to satisfy the energy required for the operation of a treatment plant. Fundamental anaerobic digestion processes include mesophilic anaerobic digestion, thermophilic anaerobic digestion and phase separation digestion processes.

With respect to conventional sludge treatment technologies, Korean Patent Application No. 2009-78028 discloses a method in which an aerobic tank is provided in a return line to induce endogenous respiration to thereby reduce sewage excess sludge. However, there is difficulty in fundamentally blocking or minimizing the discharge of sludge. In addition, Korean Patent Application No. 2012-7010541 discloses a process for the concentration, dehydration and aerobic air drying of sewage sludge, but this process requires not only the addition of a Fe³⁺-containing soluble compound, but also mechanical treatment processes, including crushing and dispersion.

In addition, the literature [Enhancement of waste activated sludge aerobic digestion by electrochemical pre-treatment, Li-Jie Song, Water research (Li-Jie Song) 44 (2010)4371-4378] discloses pre-treatment technology for converting the biopolymer material of sludge to a low-molecular-weight material using a Ti/RuO₂ mesh plate electrode, and the literature [Investigation of organic nitrogen and carbon removal in the aerobic digestion of various sludges, Environmental Monitoring and Assessment 80 (2002): 97-106, (Nevim Genc)] discloses technology for treating sludge by an aerobic digestion process. However, these technologies have a disadvantage in that energy is consumed to maintain the temperature of a digestion tank at a certain temperature.

### SUMMARY

Accordingly, the present disclosure has been made in view of the problems occurring in the prior art, and it is an object of the present disclosure to provide an apparatus and method for sewage sludge treatment and advanced sewage treatment, which can treat nutrients such as nitrogen and phosphorus while fundamentally eliminating or minimizing the discharge of excess sludge by using a combination of an advanced sewage treatment process and a sludge treatment process and applying Bacillus sp. in the sludge treatment process.

To achieve the above object, the present disclosure provides an apparatus for sewage sludge treatment and advanced sewage treatment, which includes an advanced sewage sludge treatment apparatus and a sludge treatment apparatus, the sludge treatment apparatus including: an aeration tank which is operated under aerobic conditions and serves to degrade microorganisms other than Bacillus sp. in sludge to produce organic matter to thereby activate Bacillus sp.; a poor aeration tank which is aerobically operated in a state in which a smaller amount of air is injected into the poor aeration tank in an amount smaller than that in the aeration tank, and serves to reduce the activity of microorganisms in the sludge; a spore-forming tank which is operated under oxygen-free conditions and serves to induce the degradation and death of microorganisms remaining in the sludge while inducing the formation of spores of Bacillus sp.; a Bacillus sp.-activating reactor which is provided in an internal return line extending from the spore-forming tank to the aeration tank and serves to supply minerals to the sludge returned from the spore-forming tank to activate spore-type Bacillus sp.; and a sedimentation tank which serves to induce the gravity sedimentation of the sludge discharged from the spore-forming tank to separate the discharged sludge into a supernatant and a concentrated sludge.

The sludge that is introduced into the aeration tank includes a sludge separated in the advanced sewage treatment apparatus, a concentrated sludge returned from the sedimentation tank of the sludge treatment tank, and a sludge returned from the spore-forming tank of the sludge treatment apparatus. In addition, the supernatant separated in the sedimentation tank is supplied to the advanced sewage treatment apparatus.

The minerals that are supplied to the Bacillus sp.-activating reactor include silicon (Si), magnesium (Mg) and calcium (Ca), and the sludge treatment apparatus further include a mineral supply unit for supplying minerals to the Bacillus sp.-activating reactor.

The advanced sewage treatment apparatus includes: an anaerobic tank serving to remove phosphorus (P) from influent water while denitrifying nitrite nitrogen and nitrate nitrogen; a first intermittent aeration tank and a second intermittent aeration tank, which are operated alternately under different conditions (aerobic conditions and oxygen-free conditions), serve to convert organic nitrogen and ammonia nitrogen to nitrite nitrogen and nitrate nitrogen under aerobic conditions while allowing phosphorus in influent water to be taken by phosphorus-storing microorganisms, and serve to reduce nitrite nitrogen and nitrate nitrogen into nitrogen gas under oxygen-free conditions; and a first ceramic membrane and a second ceramic membrane, which are provided in the lower portions of the first intermittent aeration tank and the second intermittent tank, respectively, and serve to produce treated water, wherein the first intermittent aeration tank and the second intermittent aeration tank are operated under different conditions, influent water discharged from the anaerobic tank is supplied to one of the first intermittent aeration tank and the second intermittent aeration tank, which is operated under aerobic conditions, and when the first intermittent aeration tank is under aerobic conditions and the second intermittent aeration tank is under oxygen-free conditions, air is injected into the first intermittent aeration tank through the first ceramic membrane to maintain the first intermittent aeration tank in aerobic conditions while treated water is discharged to the outside through the second ceramic membrane, and sludge in the second intermittent aeration tank is supplied to the aeration tank of the sludge treatment apparatus.

A method for sewage sludge treatment and advanced sewage treatment includes: performing an advanced sewage treatment process in an advanced sewage treatment apparatus; supplying sludge, accumulated in the advanced sewage treatment process, to an aeration tank of a sludge treatment apparatus, degrading microorganisms other than Bacillus sp. in the sludge under aerobic conditions, and activating Bacillus sp. in a spore state to allow the Bacillus sp. to take organic matter produced by the degradation of the microorganisms; aerobically operating a poor aeration tank while injecting air in an amount smaller than that in the aeration tank to reduce the activity of microorganisms in the sludge; supplying the sludge, discharged from the poor aeration tank, to a spore-forming tank which is operated under oxygen-free conditions, to induce the degradation and death of microorganisms remaining in the sludge while inducing the formation of spores of Bacillus sp. in the sludge; and supplying the sludge, discharged from the spore-forming tank, to a sedimentation tank to separate the sludge into a supernatant and a concentrated sludge.

The apparatus for sewage treatment and advanced sewage treatment according to the present disclosure has the following effects.

Using Bacillus sp., the discharge of sludge can be fundamentally eliminating or significantly reduced. In addition, using a combination of advanced sewage treatment and sludge treatment, the biological treatment of sewage/wastewater and the reduction in sludge can be simultaneously achieved.

### BRIEF DESCRIPTION OF THE DRAWINGS

FIG. 1 shows the configuration of an apparatus for sewage sludge treatment and advanced sewage treatment according to an embodiment of the present disclosure.

FIG. 2 is a flow chart showing the operation of an apparatus for sewage sludge treatment and advanced sewage treatment according to an embodiment of the present disclosure.

FIG. 3 schematically shows the configuration and operation of an apparatus for sewage sludge treatment and advanced sewage treatment according to an embodiment of the present disclosure.

### DETAILED DESCRIPTION

The present disclosure is characterized in that an advanced sewage treatment process and a sludge treatment process are combined with each other, and in the case of the sludge treatment process, the discharge of sludge is significantly reduced by the predominance of Bacillus sp., and in the case of the advanced sewage treatment process, a first intermittent aeration tank and a second intermittent aeration tank are sequentially disposed, and the first intermittent aeration tank and the second intermittent aeration tank are operated alternately under different conditions (aerobic conditions and oxygen-free conditions), so that influent water are subjected to both aerobic conditions and oxygen-free conditions, thereby maximizing the efficiency with which nitrogen and phosphorus are removed from the influent water. Hereinafter, an apparatus and method for sewage sludge treatment and advanced sewage treatment according to an embodiment of the present disclosure will be described in detail with reference to the accompanying drawings.

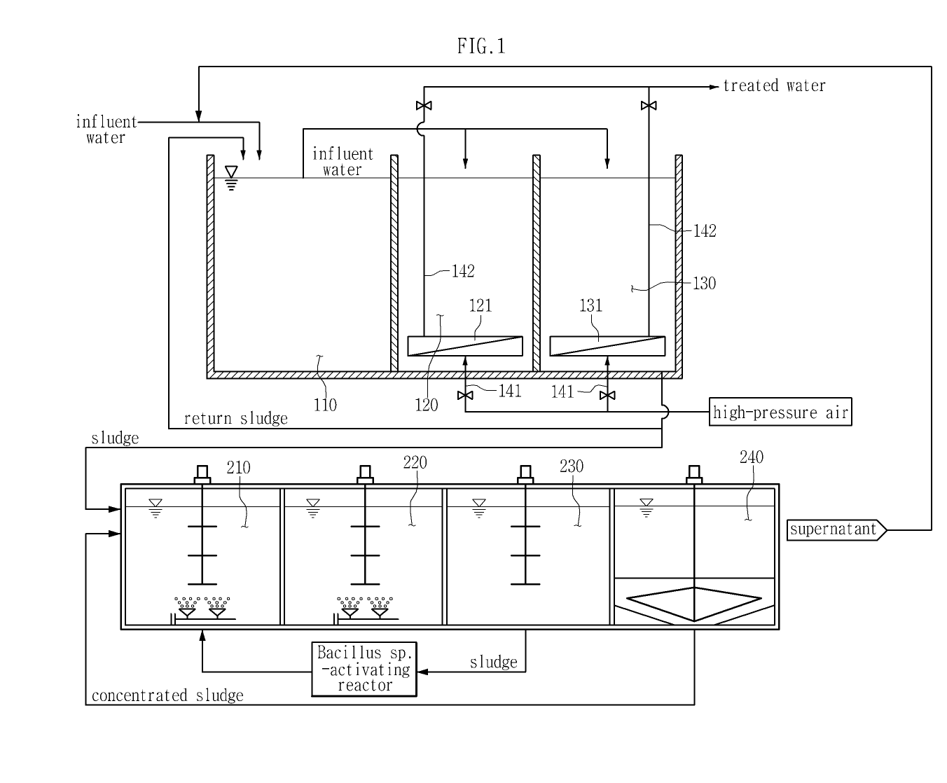

Referring to FIG. 1, an apparatus and method for sewage sludge treatment and advanced sewage treatment according to an embodiment of the present disclosure is generally composed of an advanced sewage treatment apparatus and a sludge treatment apparatus. The advanced sewage treatment apparatus serves to remove nutrients such as nitrogen and phosphorus from sewage/wastewater and finally separate the sewage/wastewater into treated water and sludge, and the sludge treatment apparatus serves to receive the sludge separated in the advanced sewage treatment apparatus and reduce the sludge using Bacillus sp.

First, the configuration of the sludge treatment apparatus will be described in detail. The sludge treatment apparatus comprises an aeration tank 210, a poor aeration tank 220, a spore-forming tank 230, a sedimentation tank 240 and a Bacillus sp.-activating reactor 250.

The aeration tank 210 serves to agitate sludge under aerobic conditions to degradation sludge microorganisms, excluding Bacillus sp. Organic matter is produced by the degradation of the microorganisms and is used as a nutrient for spore-type Bacillus sp. Meanwhile, the sludge that is supplied to the aeration tank 210 includes a sludge separated in the advanced sewage treatment apparatus, a concentrated sludge returned from the sedimentation tank 240 of the sludge treatment apparatus, and a sludge returned from the spore-forming tank 230 of the sludge treatment apparatus.

The poor aeration tank 220 serves to gradually reduce the activity of microorganisms in the sludge, sent from the aeration tank 210, using a smaller amount of injected air than that in the aeration tank 210. In the poor aeration tank 220, the sludge is stirred under aerobic conditions. As the processes of the aeration tank 210 and the poor aeration tank 220 are performed, sludge microorganisms other than Bacillus sp., are gradually reduced, and the Bacillus sp. gradually grow, as a nutrient, organic matter produced by the degradation of the microorganisms. As the Bacillus sp. grows by taking the organic matter produced by the degradation of the microorganisms, the intake of the organic matter by the Bacillus sp. means that the sludge is reduced.

The spore-forming tank 230 is operated under oxygen-free conditions and serves to induce the degradation and death of microorganisms (excluding Bacillus sp.) remaining in the sludge while inducing the formation of spores of Bacillus sp. Bacillus sp. is an aerobic bacterium, but has the property of forming spores for survival under oxygen-free conditions. As the microorganisms remaining the sludge are degraded and killed, Bacillus sp. becomes predominant in the sludge.

The sedimentation tank 240 serves to induce the gravity sedimentation of the sludge discharged from the spore-forming tank 230 to separate the sludge into a supernatant and a concentrated sludge. The separated supernatant is supplied to the advanced sewage treatment apparatus and subjected to an advanced sewage treatment process, and the concentrated sludge is returned to the aeration tank 210.

The Bacillus sp.-activating reactor 250 is provided in an internal return line extending from the spore forming tank 230 to the aeration tank 210 and serves to supply minerals contained in the sludge, which is returned from the spore-forming tank 230 to the aeration tank 210, to activate spore-type Bacillus sp. The supplied minerals activate Bacillus sp. and serve as nutrients for spore formation. The Bacillus sp. bacteria are partially activated or completely activated and are returned to the aeration tank 210. The minerals that are supplied to the Bacillus sp.-activating reactor 250 can be supplied by a mineral supply unit (not shown) provided in any position of the apparatus. The minerals that are supplied to the Bacillus sp.-activating reactor 250 include silicon (Si), magnesium (Mg), calcium (Ca) and the like.

The configuration of the sludge treatment apparatus has been described above, and the operation of the sludge treatment apparatus having this configuration will now be described.

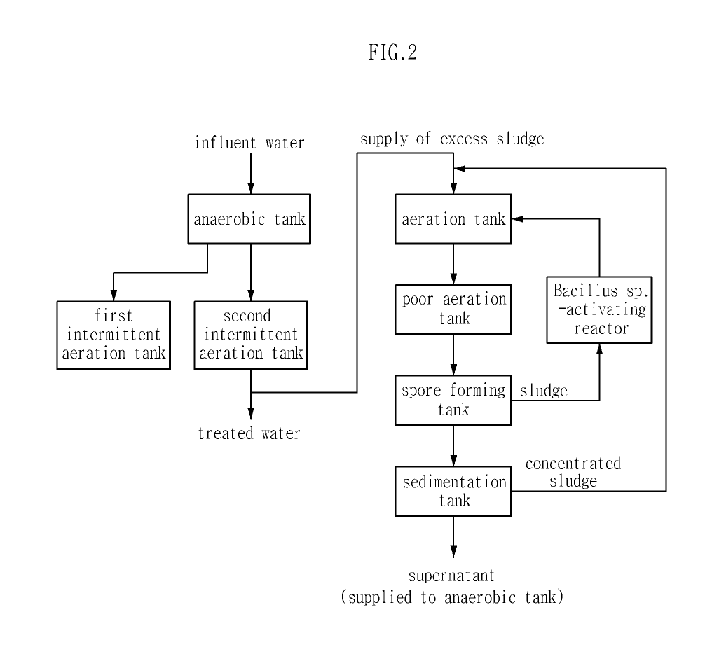

Referring to FIG. 2, sludge is first introduced into the aeration tank 210. The sludge that is introduced into the aeration tank 210 includes a sludge discharged from the advanced sewage treatment apparatus, a sludge returned from the sedimentation tank 240, and a sludge returned from the spore-forming tank 230 through the Bacillus sp.-activating reactor 250.

As the aeration tank 210 is operated with agitation under aerobic conditions, sludge microorganisms other than Bacillus sp. are degraded, and Bacillus sp. is activated in a spore state and takes organic matter produced by the degradation of the microorganisms.

The sludge aerated in the aeration tank 210 is supplied to the poor aeration tank 220. In the poor aeration tank 220, the amount of air injected therein is smaller than that in the aeration tank 210, and thus the activity of microorganisms in the sludge is gradually reduced and the activity of Bacillus sp. is more activated. The growth of Bacillus sp. and the increase in its activity are proportional to the degradation of the microorganisms, and the predominance of Bacillus sp. in the sludge is accelerated through the poor aeration tank 220.

The sludge that passed through the poor aeration tank 220 is supplied to the spore-forming tank 230. As the spore-forming tank 230 is operated under oxygen-free conditions, microorganisms remaining in the sludge are finally degraded and killed in the spore-forming tank 230, and Bacillus sp. in the sludge forms spores for survival. The predominance of the Bacillus sp. is maximized by the operation of the spore-forming tank 230, and the sludge discharged from the spore-forming tank 230 is supplied to the sedimentation tank 240.

Meanwhile, a portion of the sludge in the spore-forming tank 230 is returned to the aeration tank 210 through the Bacillus sp.-activating reactor 250, and thus Bacillus sp. activated in a spore state is supplied to the aeration tank 210 so that it takes organic matter in the aeration tank 210. The spore-type Bacillus sp. discharged from the spore-forming tank 230 is activated by taking minerals in the Bacillus sp.-activating reactor 250.

When the sludge in the spore-forming tank 230 is supplied to the sedimentation tank 240, it is subjected to gravity sedimentation in the sedimentation tank 240 and separated into a supernatant and a concentrated sludge. The supernatant is supplied to the advanced sewage treatment apparatus in which it is subjected to a series of advanced sewage treatment processes, and the concentrated sludge is returned to the aeration tank 210 in which it is subjected again to a series of sludge treatment processes.

When a series of sludge treatment processes are repeatedly performed through the aeration tank 210, the poor aeration tank 220, the spore-forming tank 230, the Bacillus sp.-activating reactor 250 and the sedimentation tank 240 as described above, the discharge of the sludge can be eliminated or minimized. In addition, in order to increase the effect of reducing sludge, a specific amount of a sludge containing predominant Bacillus sp. may be previously supplied to each of the aeration tank 210, the poor aeration tank 220 and the spore-forming tank 230.

The configuration and operation of the sludge treatment apparatus have been described above. Hereinafter, the advanced sewage treatment apparatus which performs the advanced treatment of the supernatant separated in the sludge treatment apparatus while supplying sludge to the sludge treatment apparatus will be described.

The above advanced sewage treatment apparatus can be applied to all types of advanced sewage treatment apparatuses. In other words, it can be applied to all types of advanced sewage treatment apparatuses serving to treat sewage/wastewater and discharge sludge. For example, the advanced sewage treatment apparatus can be configured to comprise an anaerobic tank, a set of intermittent aeration tanks, which are alternately operated, and a sedimentation tank, so that it can treat a supernatant and discharge sludge. The present disclosure provides an embodiment of an advanced sewage treatment apparatus, which can treat a supernatant and discharge sludge while having high biological treatment efficiency and operating efficiency.

Referring to FIGS. 1 to 3, an advanced sewage treatment apparatus according to an embodiment of the present disclosure comprises an anaerobic tank 110, a first intermittent aeration tank 120 and a second intermittent aeration tank 130. In addition, the first intermittent aeration tank 120 includes a first ceramic membrane 121, and the second intermittent aeration tank 130 includes a second ceramic membrane 131.

The anaerobic tank 110 serves to discharge phosphorus (P) from influent water and denitrify nitrite nitrogen and nitrate nitrogen. Influent water that is introduced into the anaerobic tank 110 includes externally introduced sewage/wastewater, a sludge returned from the second intermittent aeration tank 130 and a supernatant supplied from the sedimentation tank 240 of the sludge treatment apparatus. The anaerobic tank 110 includes an agitator and can achieve anaerobic conditions by controlling dissolved oxygen concentration and oxidation-reduction potential by agitation. Herein, the operation of the anaerobic tank 110 is preferably performed for about 1-2 hours.

The first intermittent aeration tank 120 and the second intermittent aeration tank 130 are operated alternately under different conditions (aerobic conditions and oxygen-free conditions). Under aerobic conditions, these aeration tanks serve to convert organic nitrogen and ammonia nitrogen to nitrate nitrogen and nitrate nitrogen and allow phosphorus in influent water to be taken by phosphorus-storing microorganisms, and under oxygen-free conditions, these aeration tanks serve to reduce nitrite nitrogen and nitrate nitrogen to nitrogen gas. A portion of the sludge produced by the operation of the second intermittent aeration tank 130 is returned to the aeration tank 110, and the remaining sludge is supplied to the aeration tank of the sludge treatment apparatus.

The first intermittent aeration tank 120 and the second intermittent aeration tank 130 are operated under different conditions. In other words, when the first intermittent aeration tank 120 is operated under aerobic conditions, the second intermittent aeration tank 130 is operated under oxygen-free conditions, and on the contrary, when the first intermittent aeration tank 120 is operated under oxygen-free conditions, the second intermittent aeration tank 130 is operated under aerobic conditions.

The first intermittent aeration tank 120 and the second intermittent aeration tank 130 receive influent water from the anaerobic tank 110 and perform the functions as described above. Depending on the operating conditions of the first intermittent aeration tank 120 and the second intermittent aeration tank 130, the pathway through which influent water from the anaerobic tank 110 changes.

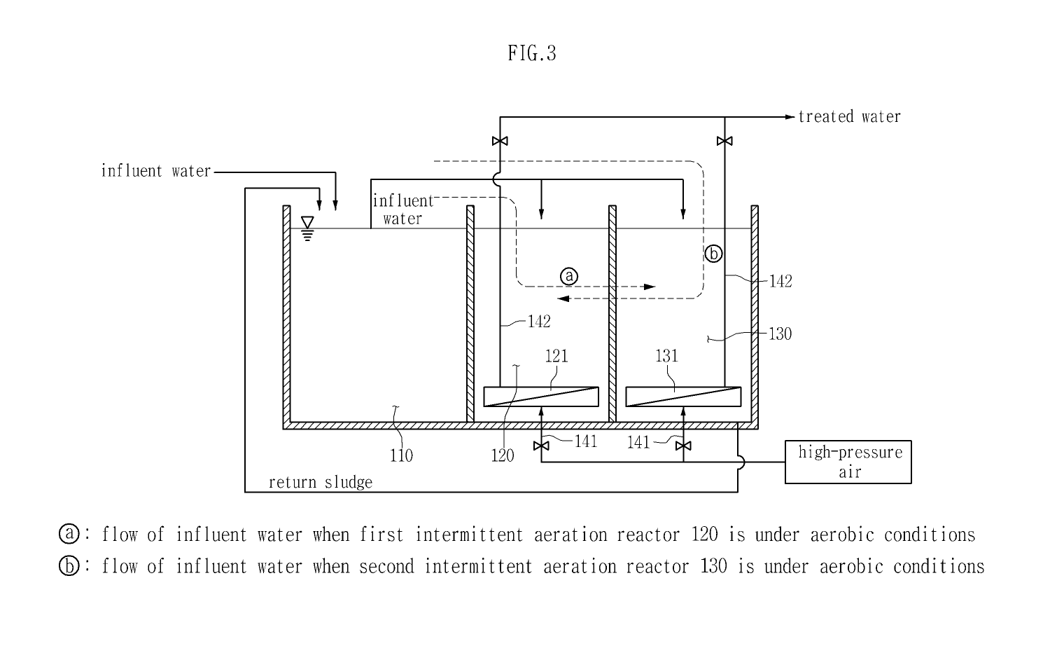

Specifically, influent water from the aerobic tank 110 is supplied only to the intermittent aeration tank that is operated under aerobic conditions. For example, when the first intermittent aeration tank 120 is operated under aerobic conditions and the second intermittent aeration tank 130 is operated under oxygen-free conditions, influent water from the anaerobic tank 110 is supplied only to the first intermittent aeration tank 120, stays in the first intermittent aeration tank 120 for a certain time, and then is supplied to the second intermittent aeration tank 130 (see FIG. 3\textcircled{a}). On the other hand, when the first intermittent aeration tank 120 is operated under oxygen-free conditions and the second intermittent aeration tank 130 is operated under aerobic conditions, influent water in the anaerobic tank 110 is supplied to the second intermittent aeration tank 130, stays in the second intermittent aeration tank 130 for a certain time, and then is supplied to the first intermittent aeration tank 120 (see FIG. 3\textcircled{b}). In other words, when the first intermittent aeration tank 120 is operated under aerobic conditions, the influent water moves from the anaerobic tank 110 through the first intermittent aeration tank 120 to the second intermittent aeration tank 130, and when the second intermittent aeration tank 130 is operated under aerobic conditions, the influent water moves from the anaerobic tank 110 through second intermittent aeration tank 130 to the first intermittent aeration tank 120.

Conventional methods employing two intermittent aeration tanks are methods of treating to and discharging influent water regardless of operating conditions (aerobic or oxygen-free conditions), and thus influent water can also be supplied to the intermittent aeration tank that is operated under oxygen-free conditions, and in this case, treatment of the influent water under aerobic conditions will necessarily be insufficient.

According to the present disclosure, influent water from the anaerobic tank 110 is supplied only to the intermittent aeration tank that is operated under aerobic conditions, after it is treated under aerobic conditions for a certain time, and then supplied to the intermittent aeration tank that is operated under oxygen-free conditions. Thus, the influent water from the anaerobic tank 110 is treated under both aerobic conditions and oxygen-free conditions, and thus phosphorus intake, nitrification and denitrification processes can be uniformly performed.

The process in which influent water from the anaerobic tank 110 moves to and stays in the first (or second) intermittent aeration tank, and the process in which the influent water from the first (or second) intermittent aeration tank moves to and stays in the second (or second) intermittent aeration tank are preferably performed during the process in which the first (or second) intermittent aeration tank is operated under aerobic conditions (or oxygen-free conditions). In addition, the residence time of the influent water in the first intermittent aeration tank 120 or the second intermittent aeration tank 130 can be controlled depending on the property of the influent water. In an embodiment, the operation under aerobic conditions and the operation under oxygen-free conditions may each be performed for 30 minutes to 1 hour.

As described above, the first ceramic membrane 121 and the second ceramic membrane 131, which are of immersion type, are provided in the lower portions of the first intermittent aeration tank 120 and the second intermittent aeration tank 130, respectively. Each of the first ceramic membrane 121 and the second ceramic membrane 131 functions to filter influent water to produce treated water. Depending on the conditions in which the first intermittent aeration tank 120 and the second intermittent aeration tank 130 are operated, the functions of the first ceramic membrane 121 and the second ceramic membrane 131 change.

In other words, when the first (or second) intermittent aeration tank is operated under oxygen-free conditions, the first (or second) ceramic membrane discharges treated water, and when the first (or second) intermittent aeration tank is operated under aerobic conditions, the discharge of treated water from the first (or second) ceramic membrane is stopped, and influent water is aerated by the first (or second) ceramic membrane.

For this, each of the first ceramic membrane 121 and the second ceramic membrane 131 is provided with an air injection line 141 and a treated water discharge line 142. The air injection line 141 serves to inject air into the first (or second) ceramic membrane so as to allow the first (or second) intermittent aeration tank to be under aerobic conditions, and the treated water discharge line 142 serves to discharge treated water produced by the first (second) ceramic membrane to the outside.

Thus, when the first (second) intermittent aeration tank is under aerobic conditions, air is injected into the first (or second) ceramic membrane through the air supply line 141 to maintain the first (second) intermittent aeration tank in aerobic conditions, and in this case, the treated water discharge line 142 is maintained in a closed state. On the contrary, when the first (or second) intermittent aeration tank is under oxygen-free conditions, the injection of air through the air injection line 141 is blocked so that the first (or second) intermittent tank is maintained in oxygen-free state, and treated water produced by the first (or second) ceramic membrane is discharged to the outside through the treated water discharge line 142. According to this configuration, any one of the first ceramic membrane 121 and the second ceramic membrane 131 discharges treated water, and thus treated water can be continuously produced for 24 hours. Separately from the discharge of treated water, the sludge in the second intermittent aeration tank is supplied to the aeration tank of the sludge treatment apparatus, and a portion of the sludge is returned to the anaerobic tank.

Meanwhile, the first ceramic membrane 121 and the second ceramic membrane 131 are made of a ceramic material such as alumina (Al₂O₃) or zirconia (ZrO₂) and include formed therein pores having a size of 0.01-0.1 μm. Thus, when high-pressure air is supplied to the first (or second) ceramic membrane through the air injection line 141, the pores in the ceramic function as a kind of aeration tube to supply air to the intermittent aeration tank. Thus, a separate aeration tube for air injection is not required. in addition, as high-pressure air is injected into the first (or second) ceramic membrane, the effect of washing the ceramic membrane can be obtained in addition to the aeration effect. In a conventional art, backwash water (treatment water) is used to wash the membrane, and thus the efficiency with which treated water is produced is reduced, whereas the present disclosure makes it possible to solve this problem.

Hereinafter, the advanced sewage treatment properties and sludge treatment properties of the apparatus for sewage treatment and advanced sewage treatment according to the present disclosure will be described. Table 1 below shows the advanced sewage treatment properties of the apparatus for sewage treatment and advanced sewage treatment according to the present disclosure, and Table 2 below shows the sludge treatment properties of the apparatus.

As can be seen in Table 1 below, the concentration of COD_{cr} in treated water was 7 mg/L, indicating that the apparatus showed a high COD_{cr} removal efficiency of 97.4%, and the concentration of suspended solids (SS) in treated water was 3.2 mg/L, indicating that the treated water has clear water quality. The concentration of total nitrogen (T-N) in raw water was about 39 mg/L, and the concentration of total nitrogen in treated water was about 4 mg/L, indicating that the apparatus showed a total nitrogen removal efficiency of about 89.74%. In addition, the concentration of total phosphorus (T-P) in treated water was about 1.7 mg/L, indicating that the apparatus showed a total phosphorus removal efficiency of 64.58%.

TABLE 1
Advanced sewage treatment efficiency

| | Concentration (mg/L) | Concentration (mg/L) | Treatment |
|---|---|---|---|
| | in raw water | in treated water | efficiency (%) |
| COD_{cr} | 272 | 7 | 97.4 |
| SS | — | 3.2 | — |
| T-N | 39 | 4 | 89.74 |
| T-P | 4.8 | 1.7 | 65.58 |

TABLE 2
Sludge treatment efficiency (operating period: 76 days)

| | | | | Treatment efficiency |
|---|---|---|---|---|
| | Input (g) | Accumulation (g) | Output (g) | (%) |
| MLSS | 361.8 | 49.4 | 2.3 | 85.7 |
| T_{COD} | 326.8 | 41.3 | 5.3 | 85.7 |
| T-N | 19 | 2.3 | 3.8 | 67.7 |
| T-P | 5.3 | 0.7 | 2.3 | 43.8 |

In Table 2 above, the input means the amount of sludge introduced into the aeration tank, and the accumulation means the amount of concentrated sludge accumulated in the sedimentation tank, and the output means the amount of sludge discharged from the sedimentation tank. As can be seen in Table 2 above, the removal efficiencies were 85.7% for MLSS, 85.7% for T_{COD}, 67.7% for T-N and 43.8% for T-P, suggesting that the apparatus of the present disclosure has a very high effect of reducing sludge.

What is claimed is:

1. An apparatus for sewage sludge treatment and advanced sewage treatment,
the apparatus comprising an advanced sewage sludge treatment apparatus and a sludge treatment apparatus, the sludge treatment apparatus comprising:
an aeration tank which is operated under aerobic conditions and serves to degrade microorganisms other than Bacillus sp. in sludge to produce organic matter to thereby activate Bacillus sp.;
a poor aeration tank which is aerobically operated in a state in which a smaller amount of air is injected into the poor aeration tank in an amount smaller than that in the aeration tank, and serves to reduce the activity of microorganisms in the sludge;
a spore-forming tank which is operated under oxygen-free conditions and serves to induce the degradation and death of microorganisms remaining in the sludge while inducing the formation of spores of Bacillus sp.;
a Bacillus sp.-activating reactor which is provided in an internal return line extending from the spore-forming tank to the aeration tank and serves to supply minerals to the sludge returned from the spore-forming tank to activate spore-type Bacillus sp.; and
a sedimentation tank which serves to induce the gravity sedimentation of the sludge discharged from the spore-forming tank to separate the discharged sludge into a supernatant and a concentrated sludge.

2. The apparatus of claim 1, wherein the sludge that is introduced into the aeration tank includes a sludge separated in the advanced sewage treatment apparatus, a concentrated sludge returned from the sedimentation tank of the sludge treatment tank, and a sludge returned from the spore-forming tank of the sludge treatment apparatus.

3. The apparatus of claim 1, wherein the minerals that are supplied to the Bacillus sp.-activating reactor include silicon (Si), magnesium (Mg) and calcium (Ca).

4. The apparatus of claim 1, further comprising a mineral supply unit for supplying the minerals to the Bacillus sp.-activating reactor.

5. The apparatus of claim 1, wherein the supernatant separated in the sedimentation tank is supplied to the advanced sewage treatment apparatus.

6. The apparatus of claim 1, wherein the advanced sewage treatment apparatus comprises:
an anaerobic tank serving to release phosphorus (P) from influent water while denitrifying nitrite nitrogen and nitrate nitrogen;
a first intermittent aeration tank and a second intermittent aeration tank, which are operated alternately under different conditions (aerobic conditions and oxygen-free conditions), serve to convert organic nitrogen and ammonia nitrogen to nitrite nitrogen and nitrate nitrogen under aerobic conditions while allowing phosphorus in influent water to be taken by phosphorus-storing microorganisms, and serve to reduce nitrite nitrogen and nitrate nitrogen into nitrogen gas under oxygen-free conditions; and
a first ceramic membrane and a second ceramic membrane, which are provided in the lower portions of the first intermittent aeration tank and the second intermittent tank, respectively, and serve to produce treated water,
wherein the first intermittent aeration tank and the second intermittent aeration tank are operated under different conditions, influent water discharged from the anaerobic tank is supplied to one of the first intermittent aeration tank and the second intermittent aeration tank, which is operated under aerobic conditions, and when the first intermittent aeration tank is under aerobic conditions and the second intermittent aeration tank is under oxygen-free conditions, air is injected into the first intermittent aeration tank through the first ceramic membrane to maintain the first intermittent aeration tank in aerobic conditions while treated water is discharged to the outside through the second ceramic membrane, and sludge in the second intermittent aeration tank is supplied to the aeration tank of the sludge treatment apparatus.

7. The apparatus of claim 6, wherein each of the first ceramic membrane and the second ceramic membrane is provided with an air injection line and a treated-water discharge line, in which the air injection line serves to inject air into the first ceramic membrane or the second ceramic membrane, and the treated-water discharge line serves to discharge treated water, produced in the first ceramic membrane or the second ceramic membrane, to the outside.

8. The apparatus of claim 7, wherein, when the first intermittent aeration tank or the second intermittent aeration tank is under aerobic conditions, air is injected into the first intermittent aeration tank or the second intermittent aeration through the air injection line while the treated-water discharge line is closed, and when the first intermittent aeration tank or the second intermittent aeration tank is under oxygen-free conditions, the injection of air through the air injection line is blocked while treated water produced in the first intermittent aeration tank or the second intermittent aeration tank is under aerobic conditions is discharged to the outside.

9. The apparatus of claim 6, wherein, when the first intermittent aeration tank is under aerobic conditions and the second intermittent aeration tank is under oxygen-free conditions, the influent water from the aeration tank is supplied to the first intermittent aeration tank, stays in the first intermittent aeration tank, and then is supplied to the second intermittent aeration tank, and when the first intermittent aeration tank is under oxygen-free conditions and the second intermittent aeration tank is under aerobic conditions, the influent water from the aeration tank is supplied to the second intermittent aeration tank, stays in the second intermittent aeration tank, and then is supplied to the first intermittent aeration tank.

10. A method for sewage sludge treatment and advanced sewage treatment, the method comprising:
performing an advanced sewage treatment process in an advanced sewage treatment apparatus;
supplying sludge, accumulated in the advanced sewage treatment process, to an aeration tank of a sludge treatment apparatus, degrading microorganisms other than Bacillus sp. in the sludge under aerobic conditions, and activating Bacillus sp. in a spore state to allow the Bacillus sp. to take organic matter produced by the degradation of the microorganisms;
aerobically operating a poor aeration tank while injecting air in an amount smaller than that in the aeration tank to reduce the activity of microorganisms in the sludge;
supplying the sludge, discharged from the poor aeration tank, to a spore-forming tank which is operated under oxygen-free conditions, to induce the degradation and death of microorganisms remaining in the sludge while inducing the formation of spores of Bacillus sp. in the sludge; and
supplying the sludge, discharged from the spore-forming tank, to a sedimentation tank to separate the sludge into a supernatant and a concentrated sludge.

11. The method of claim 10, wherein a portion of the sludge in the spore-forming tank is returned to the aeration tank, and minerals are supplied to the returned sludge to activate spore-type Bacillus sp. in the sludge.

12. The method of claim 10, wherein the sludge that is introduced into the aeration tank includes the sludge separated in the advanced sewage treatment apparatus, the concentrated sludge returned from the sedimentation tank of the sludge treatment apparatus, and the sludge returned from the spore-forming tank of the sludge treatment apparatus, and the supernatant e separated in the sedimentation tank is supplied to the advanced sewage treatment apparatus.

13. The method of claim 10, wherein the advanced sewage treatment apparatus comprises a first intermittent aeration tank and a second intermittent aeration tank, which are sequentially disposed, the first intermittent aeration tank and the second intermittent aeration tank include a first ceramic membrane and a second ceramic membrane, respectively, and in the advanced sewage treatment process, the first intermittent aeration tank and the second intermittent aeration tank are operated under different conditions, the influent water discharged from the anaerobic tank is applied to one of the first intermittent aeration tank and the second intermittent aeration tank, which is operated under aerobic conditions, and when the first intermittent aeration tank is under aerobic conditions and the second intermittent aeration tank is under oxygen-free conditions, air is injected into the first intermittent aeration tank through the first ceramic membrane to maintain the first intermittent aeration tank in aerobic conditions while treated water is discharged to the outside through the second ceramic membrane.
